(19) United States
(12) Patent Application Publication
(10) Pub. No.: US 2004/0098732 A1
(43) Pub. Date: May 20, 2004

(54) Method and system for visual consuming and publishing of web services

(76) Inventors: David John Clement, Vancouver (CA); Al Noor Kassam, Surrey (CA)

Correspondence Address: Glenn P. Rickards, DOWREY RICKARDS PLLC, Suite 106, 19119 North Creek Parkway, Bothell, WA, 98011, US

(21) Appl. No.: 10/638,276

(22) Filed: Aug. 8, 2003

Related U.S. Application Data
(60) Provisional application No. 60/402,295, filed on Aug. 9, 2002.

(51) Int. Cl. G06F 9/44

(52) U.S. Cl. 719/328; 717/109

(57) ABSTRACT

A method and system for visual publishing and consuming of web services is provided that uses a tmodel or other service specification to generate a plurality of first data descriptors from the tmodel, provide visual representations of the data descriptors, and permitting a system user to map a plurality of such data descriptors to data input needed by a data source.

### CROSS REFERENCE TO RELATED APPLICATIONS

This application claims priority from U.S. Provisional Patent Application Serial No. 60/402,295 filed Aug. 9, 2002.

### TECHNICAL FIELD

The field of the invention relates to web services and the use of a visual interface to permit simplified publishing and consumption of web services.

### BACKGROUND INFORMATION

A web service is a program interface, which, when invoked by another software program running on the same computer or on another computer with access to that computer, will perform an advertised function and then return control to the program that invoked it. The remote computer thus performs a remote procedure call. An example of a simple web service might be a service in which the service provider computer is interfaced with a thermometer and responds to the remote computer by checking the current temperature and providing it to the calling computer.

The calling program and the web service may operate on the same or on different operating platforms. For example, the web service could be running in a Microsoft environment, and the calling program could be operating on an Apple Computer system. Protocols that may be used in accessing web services include the Hypertext Transfer Protocol (“HTTP”), the Simple Object Access Protocol (“SOAP”) and the eXtended Markup Language (“XML”).

Currently, companies create their web services and advertise them on their web sites or through registries known as Universal Description, Discovery and Integration (“UDDI”) servers, that act as directories for various different web services. As part of its entry in the UDDI server, each provider of a web service makes known the service being provided and the interface definition. The interface definition must specify the data that the web service requires from a caller and what data is returned to the calling program by the web service. This information may be provided by a data structure such as a tmodel. A tmodel is a data structure representing a service type in the UDDI registry. The tmodel is an abstraction for the specification of a service type.

Users of web services normally interrogate a UDDI server to find the services that he or she is seeking, review the interface, and manually program the calling system to provide the data required by the web service and to receive the data from the web service. In addition, if more than one web service needs to be accessed, the calling system will need to be programmed in a way that will tie the various calls to the various web services together.

This approach has slowed the adoption and use of web services, as the computer programmers of the calling software must determine in advance what data needs to be sent to which service in what form, as well as how the data will be presented to the user. Moreover, web services may change over time, and this may require reprogramming the calling system.

### SUMMARY OF THE INVENTION

In one aspect of the present invention, a visual programming interface is provided to allow access to web services without requiring the skills of a programmer. The interface may allow users to visually determine the inputs to and outputs from a given web service and to orchestrate the calling of any number of web services in any sequence. In addition, the interface permits the users to respond to any changes in the web service. In another aspect, the interface exposes a web service interface as tables and allows the user to specify movement of data items to and from the web service using visual data flow metaphors, such as directional arrows. Once the user has completed specifying the orchestration of the web service or services using the visual metaphor interface, the system may then process the visual data metaphors into software logic that can be executed on demand to allow the consumption of the web service. Tmodels or similar data structure definitions are used in providing the visual interface. The visual interface includes data descriptors generated from the tmodel and these descriptors may be visually mapped to data descriptors of the database input. Likewise, data descriptors for the database output can be visually mapped to descriptors in the data output form.

The invention will become better understood upon consideration of the following description, which is intended to be taken in conjunction with the attached drawings.

### BRIEF DESCRIPTION OF THE DRAWINGS

In the drawings, like reference numerals and letters indicate like parts throughout the various views, unless indicated otherwise, and wherein:

FIG. 1 is a depiction of a publishing setup window.

FIG. 2 is a depiction of a service standard selection window.

FIG. 3 is a depiction of an icon and description.

FIG. 4 is a depiction of a data flow window.

FIG. 5 is a depiction of a message schema definition window for input.

FIG. 6 is a depiction of a message schema definition window for output.

FIG. 7 is a depiction of data flow form window.

FIG. 8 is a depiction of a message translation window.

FIG. 9 is a depiction of a message translation window.

FIG. 10 is a depiction of a transformation code form window.

FIG. 11 is a depiction of a response document.

FIG. 12 is a depiction of a graphical display of request and report icons.

FIG. 13 is a depiction of request, report and database query icons linked by graphical data flow indications.

FIG. 14 is a depiction of request, report, search encoding and database query icons linked by graphical data flow indications.

FIG. 15 is a depiction of request, report, search encoding and database query icons linked by graphical data flow indications in another configuration.

FIG. 16 is a depiction of a conditional query with icons linked by graphical data flow indications.

FIG. 17 is a depiction of a complex serial and parallel query with icons linked by graphical data flow indications.

### DETAILED DESCRIPTION OF EMBODIMENTS OF THE INVENTION

In one embodiment, a web service is generated from a service standard, also known as a tmodel. In this and other embodiments, the web service will be discussed in conjunction with web services that provide data of the type that may be consumed by a police department, such as information on incidents such as crimes, vehicle information, and information on individuals.

Once the web service is generated, a data flow diagram is generated. In order to generate a web service, the web service provider that wishes to participate in dat sharing first must provide a publishing setup. As shown in FIG. 1, the publishing setup requires the entry of a Publish URL 10, that represents the web address of the UDDI server. Also required are the address of the actual web service 12, which, in the present embodiment, is represented by an internet web address. A user name and password 14, 16 may also be provided if access to the web service is to be controlled in that manner.

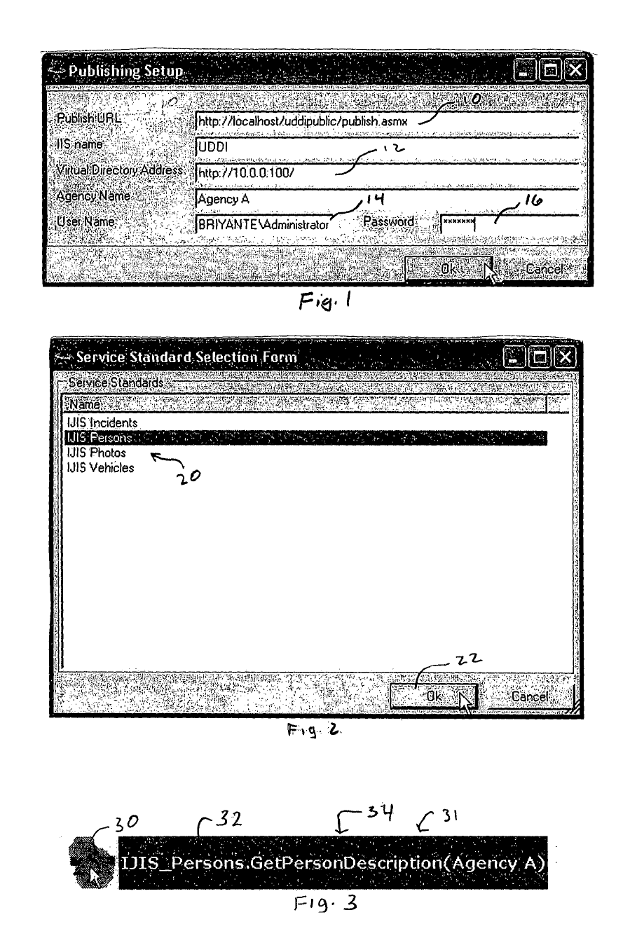

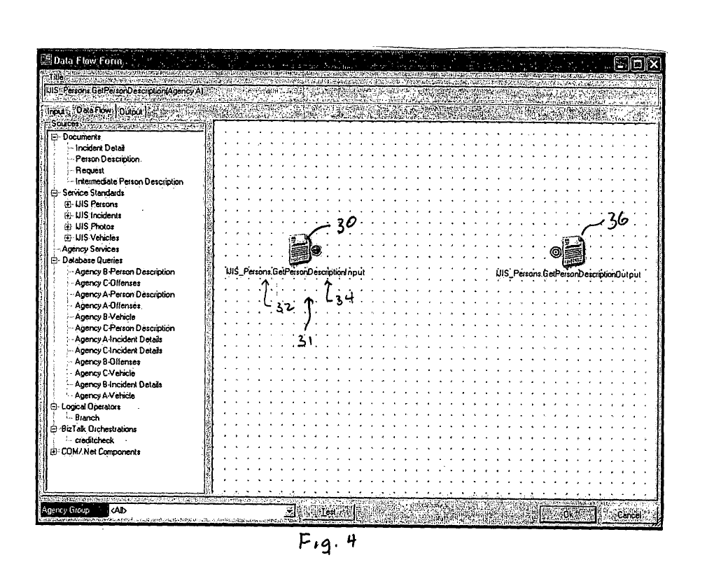

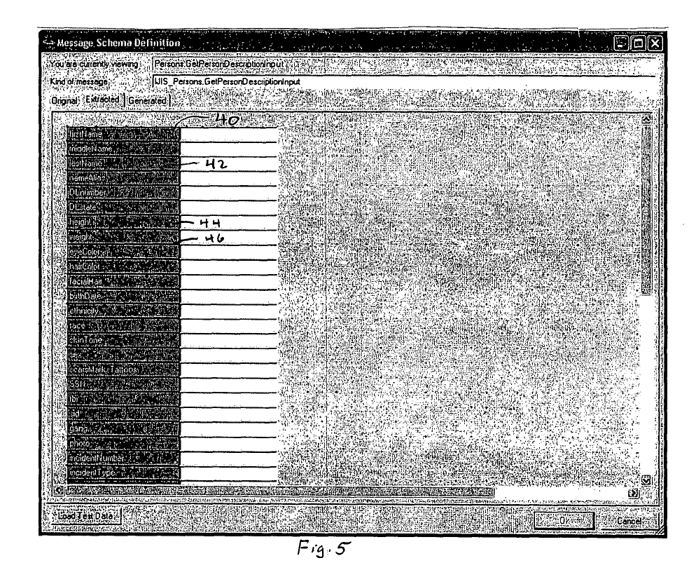

Once the publishing setup is complete, the web service can be generated from a tmodel. Referring to FIG. 2, the system provides a series of previously-established tmodels (service standards) 20. Selection of one of the tmodels 20 may be made by clicking on it and then selecting the “OK” button 22. The system then generates a web service and writes the generated web server to the system located at the web service address 12 provided during the publishing setup (FIG. 1). The URL of the generated web service is published to the UDDI server. Finally, an icon 30 is generated to represent the service, as shown in FIG. 3. The name 31 associated with this icon includes a portion 32 that is derived from the selected tmodel (i.e., IJIS Persons), as well as a web method or function portion 34 that is contained in the web service (i.e., GetPersonDescription(Agency A). As shown in FIG. 4, this icon 30 is then displayed on a data flow form, together with a corresponding data output icon 36.

The establishment of a web service has proceeded on the system has thus proceeded without the need for human programming. Rather, the various publishing functions have been called in the system The agency is the name of the provider of the web service, for example, the police department of a particular city.

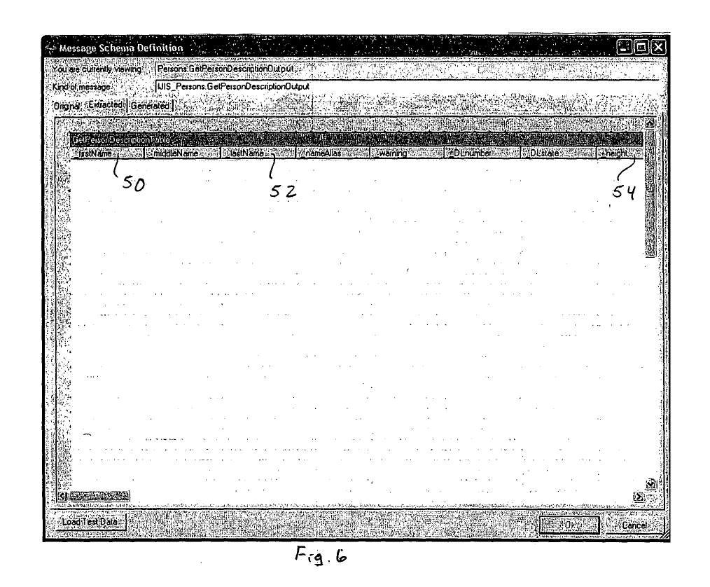

The system then allows the user to select this icon 30 by double-clicking it, and, as shown in FIG. 5, presents a message schema definition form. This form includes a number of data descriptors, such as firstName 40, lastName 42, height 44, weight 46, etc. This is the input for the web service function. Similarly, as shown in FIG. 6, clicking on the data output icon brings up a message schema definition form including like descriptors, including firstName 50, lastName 52, height 54, etc. The next step involves filling in the mappings to expose the data.

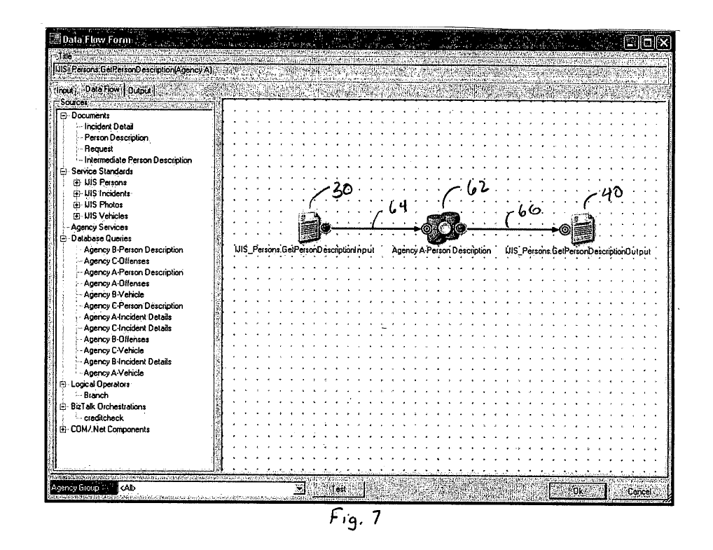

As shown in FIG. 7, the next step is to select the suitable database, in this case, that of the publishing agency. FIG. 7 displays the icons 30, 40, 62 for the input 30, database and output. Arrows are drawn between these icons by clicking on the first and dragging to the second, such as by clicking on the icon 30 and dragging the mouse to the icon 62. The arrows 64, 66 generated in this manner may now be double clicked so that the mapping between the icons can be completed.

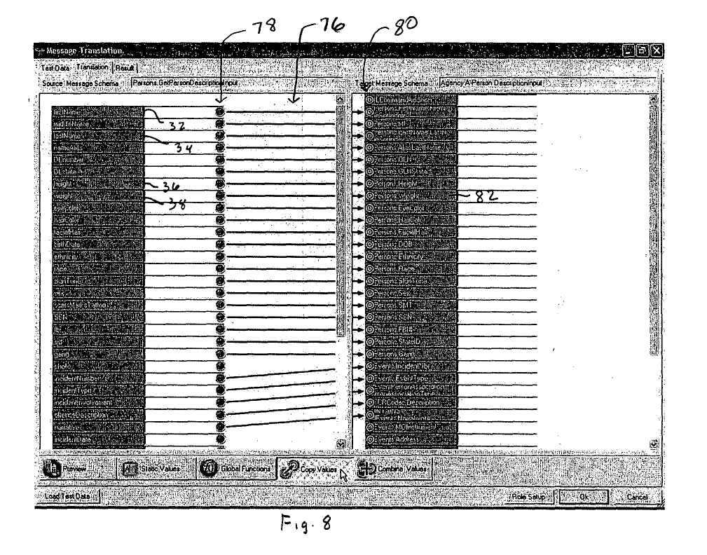

FIG. 8 shows the message translation screen that is used to define the mapping between the icons. The diagram represents how the inputs of a web service are fed into a database query. The field 70 on the right represents the descriptors from the web service, such as firstName 32 and lastName 34 as generated from the tmodel.

The field 72 on the right includes the descriptors of the information inputs to the database. Various descriptors representative of data from the first field 70 can be pointed to the database query inputs of the second field 72. The drawing of the arrows 76 to produce this mapping is completed by clicking on the source icon 78 associated with the descriptors, such as descriptors 32, 34, 36, 38, and dragging the mouse to a corresponding input icon 80, which may or may not have the same name. For example, the descriptor for weight 38 in the first field 70 may be mapped to the data input descriptor PersonWeight 82 in the database information input descriptor 82 by clicking on the icon 78 in the first field 70 associated with the descriptor 38 and dragging the mouse to the icon 80 associated with the descriptor PersonWeight 82 in the second field 72. The system then generates the code necessary to accomplish these mappings. In the event of changes, the process for remapping the descriptors merely involves redrawing the arrows 76 as described above.

The data output from the database is similarly mapped by double-clicking the arrow 66 (FIG. 7) to call up the message translation screen as shown in FIG. 9. As with the screen of FIG. 8, this screen includes two fields 90, 92 that each present a list of descriptors 94, 96 respectively representative of data output from the database and data input for the query results. Each of these has an associated output/input icon 98, 100 displayed next to it. The outputs 94 and inputs 96 may be mapped to one another by drawing arrows 102 from the associated one of the icons 98 to the associated one of the icons 100 as described above. In the present embodiment, as shown in FIG. 9, the database output descriptors 94 are presented in a different order from the input descriptors 96, requiring that the arrows be drawn at angles rather than straight across. Once again, changes in the outputs and inputs can be easily accommodated by remapping the fields 94, 96 to one another.

In a data sharing network, the data from a plurality of providers, such as police departments, may vary significantly. By using the foregoing visual method, however, the data can be easily mapped and remapped with the system providing any new code that may be required. This permits a standard form request and collects the data in a standard output form to the output data. Of course, data that is not available in a particular database cannot be mapped to a data output, and not all the available data may be requested as output. As a result, some of the descriptors 94, 96 may not have arrows 102 associated with them.

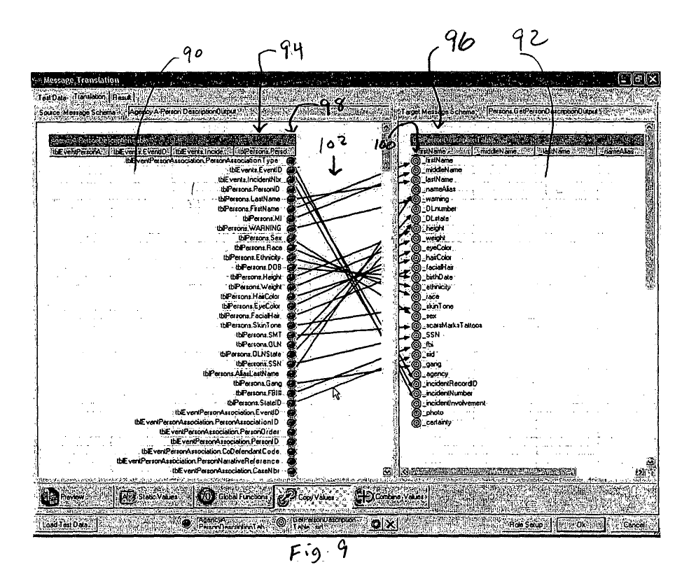

As shown in FIG. 10, translation of data may be desired. A programmer may be required to provide code for this translation. For example, if the date format available through a web service is different from the desired format, then a translation function may be provided. To add such a function, a user may click on one of the arrows 76, 102 of FIGS. 8 and 9. This calls up a translation code form that includes a coding field 110. For example, the date may be output from the database in the format of YYYYMMDD, with a four digit year, two digit month and two digit day designation. Hence, the date Dec. 25, 2003 might be presented as 20031225. The coding provided could interpret this data and rerender it in a more typical format, such as 12/25/2003 or Dec. 25, 2003.

As can be seen, this data translation is the only instance in which a user of the system may be required to produce computer coding for the system. The system logic handles the mapping of the descriptors to one another so that the desired data can be easily harvested from the database or databases.

Data can also be consumed and reports generated using a graphical interface.

The present invention is not limited to web services, but can be used with different types of data stores and other data sources. The data may be of any type, including images, text, video, audio, and multimedia data.

The underlying processes of establishing a web service, consuming data and establishing queries may be as follows:

Publishing

In order to publish a web service visually, a number of steps have to be done prior to accessing the web service.

1. Setup access to UDDI servers

2. Setup a publish-capable account on a UDDI server

3. Setup tmodels with overview documents that point to a compilable web service definition file (for example http://www.somesite.com/Test.asmx).

4. Setup a reference to that tmodel from within the publish application.

5. Setup a repository of database queries and other data acquisition techniques which will aid in the implementation of the new web service.

6. Once this reference has been created, it is possible to perform the following steps:

Use software such as a web service definition language (e.g., WSDL.exe) to generate.NET language code that will form a calling proxy for the overview document web service

Compile the generated code into a proxy assembly.

Determine what web methods are exposed by the web service by using reflection on the proxy assembly

Use these definitions to generate a new web service definition file that will form the seed of the new web service.

Generate schema definitions based on the incoming and outgoing parameters of the web methods.

Generate a query document for each web method that contains references the web service and the web methods input and output parameter schemas.

Generate the code necessary to execute the generated query when the web method is invoked.

7. Once the queries have been generated, it is possible to complete the population of the output document using a query as described below.

Consuming

In order to query web services visually, a number of steps have to be done prior to accessing the web service:

1. Setup access to UDDI servers.

2. Setup references to tmodels from within the consumer application.

3. Setup references to explicit web services from within the consumer application.

4. Setup a repository of database queries and other data acquisition techniques which will aid in the implementation of the new web service.

5. Once these references have been created, it is possible to perform the following steps:

Use a web service definition language such as WSDL.exe to generate.NET language code that will form a calling proxy for the web service.

Compile the generated code into a proxy assembly.

Determine what web methods are exposed by the web service by using reflection on the proxy assembly.

Generate schema definitions based on the incoming and outgoing parameters of the referenced web methods.

6. Now the web service is capable of acting as a data transformation element as described in query building.

Queries

A query takes the contents of a request document, whose structure is defined by a schema, and ultimately produces a report document, whose structure is defined by a schema. An example of a request document may something as simple as a single text field, or as complex as a tax return or similar document. For example, a request could be generated from the schema set forth below:

```
<?xml version=“1.0” ?>
<Schema  name=“ Request” xmlns=“urn:schemas-microsoft-com:
xml-data”
xmlns:dt=“urn:schemas-microsoft-com:datatypes”>
    <ElementType name=“Request” content=“eltOnly” >
        <AttributeType name=“param” dt:type=“string” />
        <attribute type=“param” />
    </ElementType>
</Schema>
```

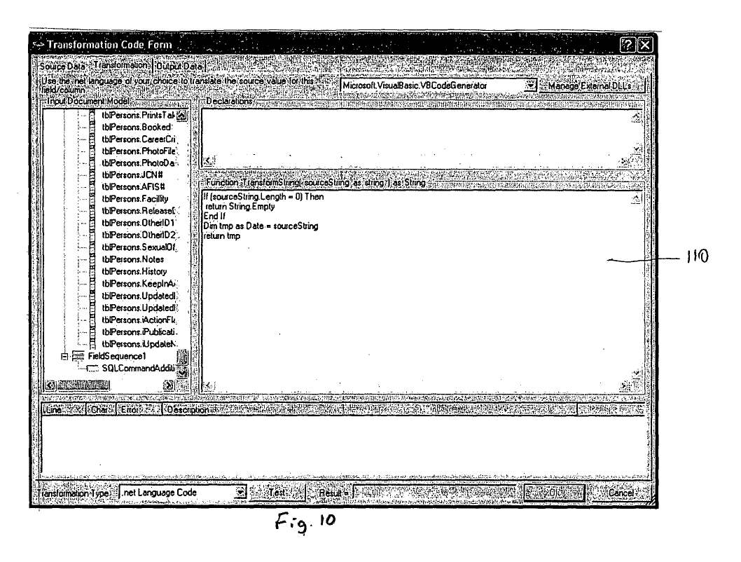

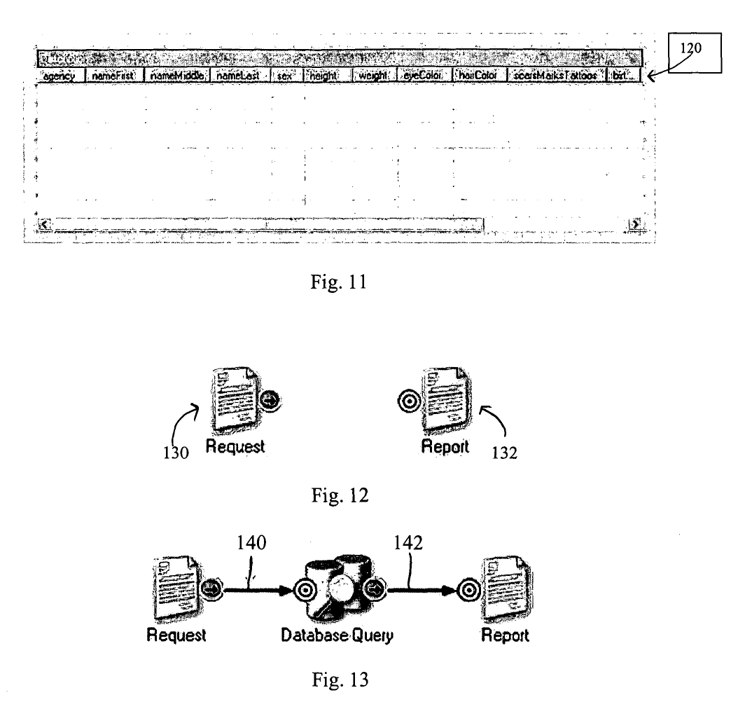

An example of a response document is typically one or more tables of information as shown in FIG. 11, including various descriptors 120.

This is generated from the schema shown below:

<?xml version=“1.0” ?>
<Schema name=“PersonDescription” xmlns=“urn:schemas-microsoft-com:
xml-data” xmlns:dt=“urn:schemas-microsoft-com:datatypes”>

<ElementType name=“Description” content=“empty”>

<AttributeType name=“agency” dt:type=“string” />
<AttributeType name=“nameFirst” dt:type=“string” />
<AttributeType name=“nameMiddle” dt:type=“string” />
<AttributeType name=“nameLast” dt:type=“string” />
<AttributeType name=“sex” dt:type=“string” />
<AttributeType name=“height” dt:type=“string” />
<AttributeType name=“weight” dt:type=“string” />
<AttributeType name=“eyeColor” dt:type=“string” />
<AttributeType name=“hairColor” dt:type=“string” />
<AttributeType name=“scarsMarksTattoos” dt:type=“string” />
<AttributeType name=“birthDate” dt:type=“string” />
<AttributeType name=“ethnicity” dt:type=“string” />
<AttributeType name=“race” dt:type=“string” />
<AttributeType name=“personalIDNumber” dt:type=“string” />
<AttributeType name=“skinTone” dt:type=“string” />
<AttributeType name=“photo” dt:type=“string” />
<AttributeType name=“certainty” dt:type=“string” />
<attribute type=“agency” />
<attribute type=“nameFirst” />
<attribute type=“nameMiddle” />
<attribute type=“nameLast” />
<attribute type=“sex” />
<attribute type=“height” />
<attribute type=“weight” />
<attribute type=“eyeColor” />
<attribute type=“hairColor” />
<attribute type=“scarsMarksTattoos” />
<attribute type=“birthDate” />
<attribute type=“ethnicity” />
<attribute type=“race” />
<attribute type=“personalIDNumber” />
<attribute type=“skinTone” />
<attribute type=“photo” />
<attribute type=“certainty” />

</ElementType>
<ElementType name=“PersonDescription” content=“eltOnly”>

<AttributeType name=“Description” dt:type=“string” />
<element type=“Description” minOccurs=“0”
maxOccurs=“*” />

</ElementType>

</Schema>

A similar schema is used to generate a report document. As shown in FIG. 12, the request and report schema are represented to the user of the system as request and report icons 130, 132.

Once these two documents have been defined, it is possible to add as many data transformation elements to the query as desired. Data transformation elements have the following properties: They take a document of some kind as their input, and produce a document based on the contents of the incoming document or information derived from said document. Examples of data transformation elements:

SQL database queries

Web Method calls

Function/procedure calls

COM(+) Components

Queries themselves.

Since some of these examples require helper code to gain access to the base element, it is assumed that each of the data transformation elements may be wrapped in a helper class of some kind in order that it be compliant with the definition stated above. The converse of this is that any software that can be wrapped in such a way as to make it compliant with the above definition could be considered a data transformation element.

Once a data transformation element has been added it is possible to feed the output of either the request document, or an intervening data transformation element to the input of either the report, or an intervening data transformation element. This may be represented as an arrow 140, 142 as shown in FIG. 13.

An arrow actually represents a document translation that can transform the structure of a document from that defined by start elements output schema to the end documents input schema. Schema based document translation already exists in a number of technologies such as XSLT, and is not discussed further in this document.

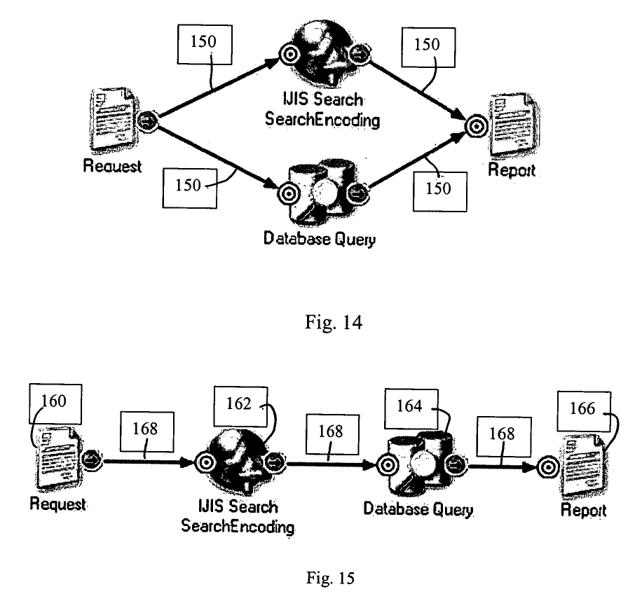

It is also possible to merge data from two independent data transformation elements into a single output, as shown in FIG. 14 by providing the appropriate arrows 150 linking the report, data sources and the like. In this example, the data from both outputs is combined to produce a single coherent input to the target document.

As shown in FIG. 15, it is also possible to take the output of one transformation element and use it as the input to a subsequent transformation elements, again by selecting the icons representing the request 160, encoding 162, database query 164 and report 166 and drawing arrows 168 between them.

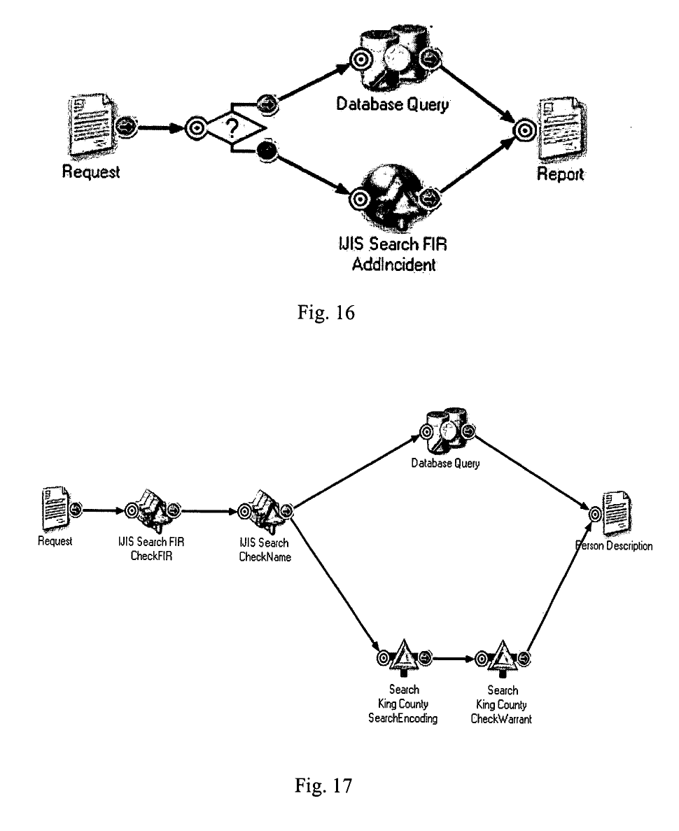

It is also possible to select one of two transformation paths based on data in the output document of one of the transformation elements as shown in FIG. 16. As an example, an officer with access to a number of services might use the method and system of an embodiment of the present invention to quickly obtain information needed for a criminal investigation. Starting with a field incident reported by a witness, a query could be made to a field incident report web service that outputs the name and address of the vehicle owner, among other data, by drawing an arrow (or some other form of visual representation of the data flow). The name and address returned by the WEB Service could then be routed to a driver's license web service that provides driver's license number, address, photographic image, age and description information, again using the visual metaphor for data flow. The address from the vehicle license web service could also be used to query the driver license web service for persons with driver licenses giving the same address, and the names, driver license numbers, address, photographic image, age and description information could be sent to local and state criminal information web service to check for outstanding warrants. Finally, all this information could be routed to the report, as illustrated in FIG. 17.

Of course, while the invention has been discussed in connection with WEB Services such as UDDI WEB services, such services and other information sources may reside on and be accessed using the present invention over a computer network, VPN, WAN, or on a computer otherwise remotely accessible by the user's computer. The services might even reside on the user's own computer.

Although specific embodiments of the invention have been disclosed herein for the purpose of illustration, various modifications and additions may be made without deviating from the spirit and scope of the invention. The scope of protection of the invention should thus be determined by reference to the appended claims.

We claim:

1. A visual method for generating a web service in a computer system comprising the steps of:
receiving user input in a computer system to select a service specification;
generating in the computer system from the service specification a visual representation of a plurality of data descriptors for data input to the system from the service specification;
generating a plurality of data source data descriptors for data input to a data source;
presenting a visual output to the user on a computer screen of the computer system of a plurality of data descriptors for data input to the computer system and of the plurality of data input data descriptors;
receiving user input in the computer system of mapping selected ones of the plurality of data descriptors to selected ones of the plurality of data source data descriptors and presenting a visual representation of data flow connecting the selected ones of the plurality of data descriptors to the selected ones of the data source data descriptors.

2. A method of providing user access to data sources comprising:
providing a representation of data input for sending to at least one data source on a computer display;
providing a representation of data output from the data source;
receiving from the user the input of a visual metaphor representative of data to be sent to a data source and of data to be received from a data source;
translating the visual metaphors into a data request having a format compatible with the data source.

3. The method of claim 2 further comprising the step of receiving the data from the data source and producing a report containing information from the data source

4. A method of acquiring data from a data source comprising:
receiving in a computer system data identifying input and output requirements and formats for a data source;
displaying a visual representation of the data source;
receiving user data selection instructions for data output from the data source;
retrieving the data corresponding to the user data selection instructions from the data source;
creating a report containing the data.
